(19) United States
(12) Patent Application Publication
(10) Pub. No.: US 2001/0055155 A1
(43) Pub. Date: Dec. 27, 2001

(54) Optical system for observing equipment having image-vibration compensation system

(75) Inventors: Moriyasu Kanai, Tokyo (JP); Koichi Maruyama, Saitama-ken (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/902,255

(22) Filed: Jul. 11, 2001

Related U.S. Application Data
(62) Division of application No. 09/222,884, filed on Dec. 30, 1998.

(30) Foreign Application Priority Data
Jan. 6, 1998 (JP) HEI 10-1171

(51) Int. Cl. G02B 27/64

(52) U.S. Cl. 359/557; 359/554; 359/407

(57) ABSTRACT

An optical system for a binocular is provided with an objective optical system, an erecting system and an eyepiece. The objective optical system includes a front lens group having positive refractive power, and a rear lens group having negative refractive power. The rear lens group is capable of moving in a direction orthogonal to an optical axis to stabilize an image when the binocular is moved due to hand-held shaking of a user. The objective optical system satisfies the following condition:

0.2<m<4.0

where m is magnification of the rear lens group.

This is a divisional of U.S. application Ser. No. 09/222,884 filed Dec. 30, 1998, the contents of which are expressly incorporated by reference herein in their entireties.

### BACKGROUND OF THE INVENTION

The present invention relates to an optical system for observing equipment such as a binocular or a terrestrial telescope that has an image-vibration compensation system.

Recently, binoculars provided with image-vibration compensation systems for preventing vibration of observed image due to hand-held shaking of a user have been developed. Japanese Laid Open Publication No. HEI 6-43365 discloses an image-vibration compensation system of a binocular that employs variable angle prism for each of telescopic optical systems of the binocular. A variable angle prism is located between an objective lens and an erecting system. When the optical system vibrates due to hand-held shaking of a user, the vertex angle of the variable angle prism is controlled to stabilize the image.

In such a construction, however, since the variable angle prism is located in the convergent light, if the vertex angle of the prism is changed, decentering coma occurs largely.

Another example of the image-vibration compensation system for binoculars is disclosed in Japanese Laid Open Publication No HEI 6-308431. The binocular in the publication employs a compensation device that is attached in front of the objective optical systems of the binocular. Since the first lens of the objective optical system has the largest diameter in the telescopic optical system, in general, and the device is arranged in front of the first lenses, the device becomes large in size, which increases the size of the binocular.

### SUMMARY OF THE INVENTION

It is therefore an object of the present invention to provide an optical system of an observing equipment having image-vibration compensation system, which is compact in size.

For the above object, according to the present invention, there is provided an optical system of an observing equipment having an image-vibration compensation system. The optical system includes an objective optical system that includes:

a front lens group having positive refractive power; and

a rear lens group having negative refractive power, the lens groups being arranged in the order from an object side, wherein the rear lens group is movable in a direction perpendicular to an optical axis of the objective optical system to compensate a vibration of an image due to a hand-held shaking, and

wherein condition (1) is satisfied:

1.2<m<4.0 (1)

where,

m is magnification of the rear lens group.

With this construction, since the compensation element is a part of the objective optical system located at the image side in the objective optical system, the size of the compensation element becomes smaller than the conventional element which is located at the object side of the objective optical system.

The rear lens group may consist of a single negative lens of which both surfaces are spherical. In this case, it is preferable to satisfy condition (2):

1<(R₁+R₂)/(R₁−R₂)<5 (2)

where,

R₁ is a radius of curvature of the object side surface of the negative lens, and

R₂ is a radius of curvature of the image side surface of the negative lens.

On the contrary, the rear lens group may consist of a single negative aspherical lens of which thickness at periphery is smaller than that of a spherical lens having the same paraxial radius of curvature. In this case, it is preferable to satisfy condition (3):

−5<(Ra₁+Ra₂)/(Ra₁−Ra₂)<1 (3)

where,

Ra₁ is a paraxial radius of curvature of the object side surface of the negative lens, and

Ra₂ is a paraxial radius of curvature of the image side surface of the negative lens.

In the another embodiment, the rear lens group may consist of a positive lens and a negative lens so that chromatic aberration of the rear lens group is corrected.

In the preferred embodiments, the front lens group consists of a positive lens and a negative lens that are cemented to each other.

Optionally, the optical system may further include an eyepiece through which a user observes an image formed by the objective optical system. The optical system may still further include erecting system that is located between the objective optical system and the eyepiece.

### DESCRIPTION OF THE ACCOMPANYING DRAWINGS

FIG. 1 is a plane view of a binocular that employs an optical system of the present invention with showing one of two telescopic optical systems;

FIG. 2 is a front view of the binocular shown in FIG. 1;

FIG. 3 schematically shows a structure of the driving mechanism shown in FIG. 1;

FIG. 4 is a block diagram illustrating a control system for controlling the driving mechanism;

FIG. 5 is a lens diagram showing a telescopic optical system according to a first embodiment;

FIGS. 6A through 6D show various aberrations of the telescopic optical system shown in FIG. 5;

FIG. 7A shows transverse aberration of the telescopic optical system shown in FIG. 5 when any lens groups are not decentered;

FIG. 7B shows transverse aberration of the telescopic optical system shown in FIG. 5 when the rear lens group is decentered to stabilize an image when a tilt angle is 1 degree;

FIGS. 8A and 8B show astigmatisms of the telescopic optical system shown in FIG. 5 when the rear lens group is decentered to stabilize an image when a tilt angle is 1 degree;

FIG. 9 is a lens diagram showing a telescopic optical system according to a second embodiment;

FIGS. 10A through 10D show various aberrations of the telescopic optical system shown in FIG. 9;

FIG. 11A shows transverse aberration of the telescopic optical system shown in FIG. 9 when any lens groups are not decentered;

FIG. 11B shows transverse aberration of the telescopic optical system shown in FIG. 9 when the rear lens group is decentered to stabilize an image when a tilt angle is 1 degree;

FIGS. 12A and 12B show astigmatisms of the telescopic optical system shown in FIG. 9 when the rear lens group is decentered to stabilize an image when a tilt angle is 1 degree;

FIG. 13 is a lens diagram showing a telescopic optical system according to a third embodiment;

FIGS. 14A through 14D show various aberrations of the telescopic optical system shown in FIG. 13;

FIG. 15A shows transverse aberration of the telescopic optical system shown in FIG. 13 when any lens groups are not decentered;

FIG. 15B shows transverse aberration of the telescopic optical system shown in FIG. 13 when the rear lens group is decentered to stabilize an image when a tilt angle is 1 degree;

FIGS. 16A and 16B show astigmatisms of the telescopic optical system shown in FIG. 13 when the rear lens group is decentered to stabilize an image when a tilt angle is 1 degree;

FIG. 17 is a lens diagram showing a telescopic optical system according to a fourth embodiment;

FIGS. 18A through 18D show various aberrations of the telescopic optical system shown in FIG. 17;

FIG. 19A shows transverse aberration of the telescopic optical system shown in FIG. 17 when any lens groups are not decentered;

FIG. 19B shows transverse aberration of the telescopic optical system shown in FIG. 17 when the rear lens group is decentered to stabilize an image when a tilt angle is 1 degree;

FIGS. 20A and 20B show astigmatisms of the telescopic optical system shown in FIG. 17 when the rear lens group is decentered to stabilize an image when a tilt angle is 1 degree;

FIG. 21 is a lens diagram showing a telescopic optical system according to a fifth embodiment;

FIGS. 22A through 22D show various aberrations of the telescopic optical system shown in FIG. 21;

FIG. 23A shows transverse aberration of the telescopic optical system shown in FIG. 21 when any lens groups are not decentered;

FIG. 23B shows transverse aberration of the telescopic optical system shown in FIG. 21 when the rear lens group is decentered to stabilize an image when a tilt angle is 1 degree;

FIGS. 24A and 24B show astigmatisms of the telescopic optical system shown in FIG. 21 when the rear lens group is decentered to stabilize an image when a tilt angle is 1 degree;

FIG. 25 is a lens diagram showing a telescopic optical system according to a sixth embodiment;

FIGS. 26A through 26D show various aberrations of the telescopic optical system shown in FIG. 25;

FIG. 27A shows transverse aberration of the telescopic optical system shown in FIG. 25 when any lens groups are not decentered;

FIG. 27B shows transverse aberration of the telescopic optical system shown in FIG. 25 when the rear lens group is decentered to stabilize an image when a tilt angle is 0.5 degrees; and

FIGS. 28A and 28B show astigmatisms of the telescopic optical system shown in FIG. 25 when the rear lens group is decentered to stabilize an image when a tilt angle is 0.5 degrees.

### DESCRIPTION OF THE EMBODIMENTS

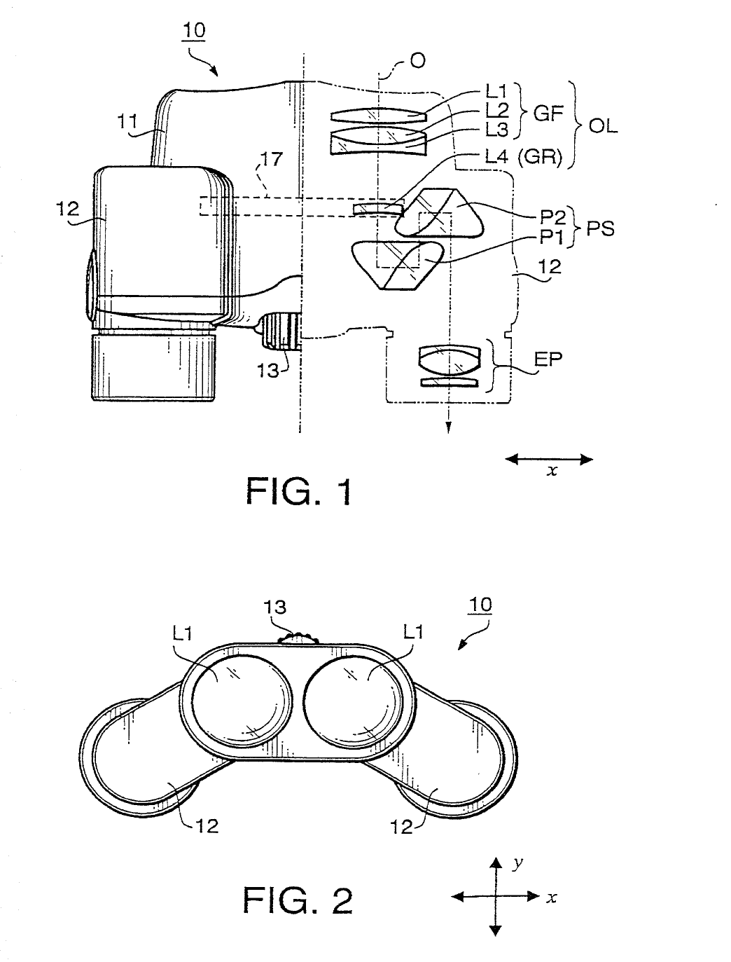

FIG. 1 shows a binocular 10 that employs a pair of telescopic optical systems according to the invention. The binocular 10 also employs an image-vibration compensation system. FIG. 2 shows a front view of the binocular 10. The binocular 10 includes a center body 11 and a pair of grip portions 12 that are connected to the center body 11 at right and left side thereof, respectively. The grip portions 12 are rotatable with respect to the center body 11 in order to adjust a distance therebetween to fit a pupil distance of a user. A diopter adjusting dial 13 is attached to a rear portion of the center body 11.

The binocular 10 is provided with right and left telescopic optical systems arranged side by side for right and left eyes of the user. Since the left telescopic optical system is symmetric to the right telescopic optical system, FIG. 1 shows elements included in the right telescopic optical system, and description is directed therefor.

The telescopic optical system consists of an objective optical system OL for forming an image of an object, an erecting system PS for erecting the image, and an eyepiece EP.

The objective optical system OL, which is provided in the center body 11, is a telephoto lens that includes a front lens group GF having positive refractive power and a rear lens group GR having negative refractive power. The front and rear lens groups GF and GR are arranged in this order from an object side. The front lens group GF consists a positive first lens L1, a positive second lens L2 and a negative third lens L3. The second and third lenses are cemented to each other. Alternatively, the front lens group GF may consist of a doublet such as the cemented lenses L2 and L3 without the first lens L1.

The rear lens group GR consists of a negative fourth lens L4. The fourth lens L4 is a spherical lens, both surfaces of which are spherical. However, the rear lens group GR may be an aspherical lens, at least one surface of which is formed as an aspherical surface. Further, the rear lens group GR may consists of a positive lens and a negative lens so that chromatic aberration thereof is corrected.

The fourth lens L4 (i.e., the rear lens group GR) is mounted on a driving mechanism 17 that moves the fourth lens L4 in first and second directions perpendicular to an optical axis O of the objective optical system OL.

The objective optical system OL forms an inverted image, and the inverted image is erected into proper orientation through the erecting system PS. The erecting system PS is provided with a first prism P1 and a second prism P2, which constitute type II Porro prism system. The first prism P1 has two reflection surfaces for rotating the image by 90 degrees, and the second prism PS2 also has two reflection surfaces for further rotating the image by 90 degrees.

The eyepiece EP has five lenses through which a user observes the image erected by the erecting system PS. The objective optical system OL and the first prism P1 is arranged in the center body 11, and the second prism P2 and the eyepiece EP are arranged in the grip portion 12.

The grip portion 12 is rotatable, with respect to the center body 11, about the optical axis O of the objective optical system OL. The erecting system PS and the eyepiece EP are rotated together with the grip portion 12. The left and right grip portions rotate in the opposite directions, and the user can adjust the distance between the left and right eyepieces to correspond to the pupil distance of the user.

In this specification, an x-axis direction that is the first direction and a y-axis direction that is the second direction are defined with respect to the binocular 10. The y-axis direction is defined as a direction that is perpendicular to a plane including the optical axes O of both the right and left telescopic optical systems. The x-axis direction is defined as a direction, which is parallel to a plane perpendicular to the optical axis O, and is perpendicular to the y-axis direction. Thus, the x-axis and y-axis are perpendicular to each other, and both are orthogonal to the optical axis O.

The driving mechanism 17 drives the fourth lens L4 in the x-axis and y-axis directions such that the image viewed by a user is stabilized even when a hand-held shaking is applied to the binocular 10.

At the initial or neutral position of the fourth lens L4, the optical axis of the fourth lens L4 is coincident with the optical axis O of the first through third lenses L1, L2 and L3.

When the object side of the binocular 10 moves, relatively to the eyepiece side, in the y-axis direction due to a hand-held shaking, the driving mechanism 17 moves the fourth lens L4 in the y-axis direction so that a position of an image is maintained. Similarly, when the object side of the binocular 10 moves, relatively to the eyepiece side, in the x-axis direction due to the hand-held shaking, the driving mechanism 17 moves the fourth lens L4 in the x-axis direction so that the image position is maintained. In this specification, the angle formed between the optical axes O before and after the binocular 10 has been moved in the y-axis direction is referred to as a tilt angle in the y-axis direction, and the angle formed between the optical axes O before and after the binocular 10 has been moved in the x-axis direction is referred to as a tilt angle in the x-axis direction. It should be noted that the hand-held shaking applied to the binocular 10 can be represented by the tilt angle(s) in the x-axis and/or y-axis directions, and accordingly, the image can be stabilized by moving the fourth lens L4 in the x-axis and/or y-axis direction.

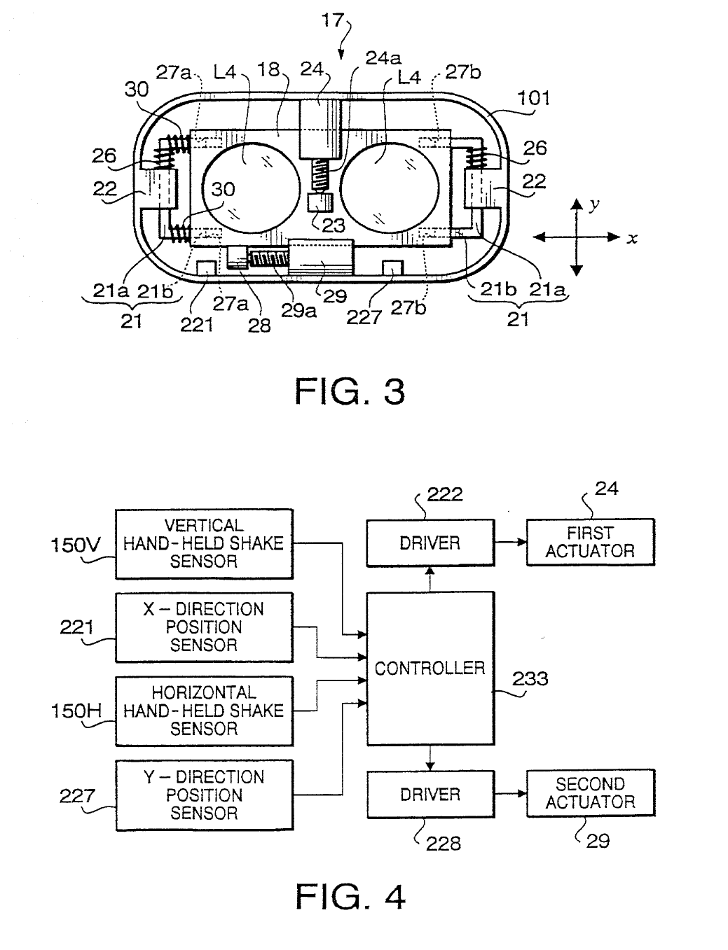

FIG. 3 shows an example of the driving mechanism 17 for driving the fourth lens L4.

The driving mechanism 17 includes a rectangular lens frame 18 that holds the fourth lenses L4 of both the telescopic optical systems at openings formed thereon, a first actuator 24 for linearly shifting the rectangular lens frame 18 in the y-axis direction and a second actuator 29 for linearly shifting the frame 18 in the x-axis direction.

At longitudinal side ends of the lens frame 18, a pair of guide bars 21 and 21 are provided. The guide bar 21 has a center bar 21a and edge bars 21b formed at both edges of the center bar 21a. Both of the edge bars 21b are perpendicular to the center bar 21a and are directed to the same direction. The guide bars 21 and 21 are arranged such that the center bars 21a and 21a are parallel to the y-axis and that the tip ends of the edge bars 21b and 21b are faced to the rectangular lens frame 18.

The center bars 21a and 21a of the guide bars 21 and 21 are slidably fitted in through-holes formed in a pair of supports 22 and 22 that are formed inside the body 101 of the binocular.

The tip ends of the edge bars 21b of the one guide bars 21 are slidably inserted into holes 27a and 27a formed at one side end of the rectangular lens frame 18. The tip ends of the edge bars 21b of the other guide bars 21 are slidably inserted into holes 27b and 27b formed at the opposite side end of the rectangular lens frame 18.

With this structure, the lens frame 18 is movable in the y-axis direction and in the x-axis direction.

The first and second actuator 24 and 29 are secured on the inner surface of the body 101 of the binocular. A plunger 24a of the first actuator 24 is capable of protruding/retracting in the y-axis direction. The plunger 24a abuts a projection 23 formed on the lens frame 18 between the pair of fourth lenses L4. Further, coil springs 26 and 26 are provided to the center bars 21a and 21a to bias the lens frame 18 in the upward direction in FIG. 3 with respect to the body 101 of the binocular.

A plunger 29a of the second actuator 29 is capable of protruding/retracting in the x-axis direction. The plunger 29a abuts a projection 28 formed on the side of the lens frame 18. The coil springs 30 and 30 are provided to the edge bars 21b and 21b of the one guide bar 21 to bias the lens frame 18 in the rightward direction in FIG. 3.

When electrical power is applied to the first actuator 24 to make the plunger 24a protrude, the plunger 24a pushes the projection 23 to linearly move the rectangular lens frame 18 in the downward direction in FIG. 3. When the electrical power for retracting the plunger 24a is applied to the actuator 24, due to force of the coil springs 26, the projection 23 is kept contacting the plunger 24a, i.e., the lens frame 18 moves in the upward direction in FIG. 3.

In the same manner, when the electrical power is applied to the second actuator 29 to make the plunger 29a protrude, the projection 28 is pushed to linearly move the rectangular lens frame 18 in the leftward direction in FIG. 3. When the electrical power for retracting the plunger 29a is applied, the lens frame 10 moves in the rightward direction in FIG. 3 due to force of the coil springs 30 and 30.

When the fourth lens L4 is moved in the y-axis direction, the image in the user view moves in the vertical (up/down) direction. Accordingly, by controlling the first actuator 24, the vertical movement of the image due to the vertical hand-held shaking can be compensated, while by controlling the second actuator 29, the horizontal movement of the image due to the horizontal hand-held shaking can be compensated.

Further, the driving mechanism 17 is provided with an x-direction position sensor 221 and a y-direction position sensor 227 that are also secured to the body 101 of the binocular. The position sensor may be an optical sensor having a light emitting element and a position sensitive device (PSD).

As shown in FIG. 4, the first and second actuators 24 and 29 are controlled by a controller 233 through drivers 222 and 228, respectively. The controller 233 controls the drivers 222 and 228 based on the signals from a vertical hand-held shaking sensor 150V, a horizontal hand-held shaking sensor 150H, the x-direction position sensor 221, and the y-direction position sensor 227.

The controller 233 calculates amount of movements of the binocular in the vertical and horizontal directions due to the hand-held shaking, and controls the drivers 222 and 228 to drive the first and second actuators 24 and 29 by an amount corresponding to the amount of movement of the image due to the hand-held shaking. Specifically, the controller 233 determines a target position to which the lens frame 18 is to be positioned for canceling change of the position of the image due to the hand-held shaking based on the amount of movement detected by the hand-held shaking sensors 150V and 150H. Then, the controller 233 controls the driver to move the lens frame 18 to the calculated target position with monitoring the position detected by the position sensors 221 and 227. As the above control is continuously executed, the controller 233 continuously updates the target position, and accordingly, trembling of the images due to the hand-held shaking is compensated.

Since the objective optical system OL is a telephoto lens, the entire length of the objective optical system OL can be small. According to the embodiment, the objective optical system satisfies condition (1):

1.2<m<4.0 (1)

where,

m is magnification of the rear lens group.

Condition (1) defines a magnification of the rear lens group GR that corresponds to a decentering sensitivity thereof. If condition (1) is satisfied, the rear lens group GR has a preferable decentering sensitivity, which allows a compact design of the objective optical system CL. The decentering sensitivity is defined as a ratio of the tilt angle due to hand-held shaking with the decentering amount of the compensation lens group to stabilize an image. If the magnification m is smaller than the lower limit, the decentering sensitivity becomes too small to make the compensation system be compact. If the magnification m is larger than the upper limit, the decentering sensitivity becomes so large that a fine control of the image-vibration compensation is difficult.

In the image-vibration compensation system of the lens decentering type, inertial mass of the compensation lens group should be as small as possible to lower load for the driving mechanism. Thus, it is preferable that the compensation lens group consists of a single lens. A plastic lens is also preferable for the compensation lens group because it is light in weight as compared with a glass lens.

Further, a lens having large spherical aberration generates large decentering coma when the lens is decentered due to image-vibration compensation. Thus the spherical aberration of the compensation lens group should be as small as possible. When the compensation lens group consists of a single spherical lens, both surfaces of which are spherical, it is desirable-to satisfy condition (2):

1<(R₁+R₂)/(R₁−R₂)<5 (2)

where,

R₁ is a radius of curvature of the object side surface of the negative lens, and

R₂ is a radius of curvature of the image side surface of the negative lens.

Condition (2) defines shape factor of the spherical lens of the rear lens group. Although a spherical lens is easy to manufacture at low cost, it cannot completely correct spherical aberration. However, if the condition (2) is satisfied, the spherical aberration can be small. If the shape factor is smaller than the lower limit or larger than the upper limit, the spherical aberration becomes so large that the rear lens group generates the decentering coma when the rear lens group is decentered.

As the decentering amount of the compensation lens group becomes larger, a meridional image plane is inclined due to the decentering, which causes the unbalanced defocus. On the other hand, it is known that a lens having coma generates the inclination of the meridional image plane when the lens is decentered. Thus, the rear lens group has an appropriate coma, the inclination of the meridional image plane can be counterbalanced. In this case, the rear lens group GR should be an aspherical lens of which thickness at periphery is smaller than that of a spherical lens having the same paraxial radius of curvature in order to correct spherical aberration. Further preferably, the aspherical lens may satisfy condition (3):

−5<(Ra₁+Ra₂)/(Ra₁−Ra₂)<1 (3)

where,

Ra₁ is a paraxial radius of curvature of the object side surface of the aspherical lens, and

Ra₂ is a paraxial radius of curvature of the image side surface of the aspherical lens.

Condition (3) defines coma of the aspherical lens of the rear lens group GR. When the rear lens group consists of the single aspherical lens and the aspherical surface is designed so that thickness of the aspherical lens increases as the distance from an optical axis increases, the unbalanced defocus due to the inclination of the meridional image plane can be corrected when the condition (3) is satisfied if the ratio of the condition (3) is smaller than the lower limit, coma of the aspherical lens becomes so large that the unbalanced defocus is enlarged. If the ratio is larger than the upper limit, coma of the aspherical lens becomes too small to counterbalance the inclination of the meridional image plane due to the decentering.

[Numerical Embodiments]

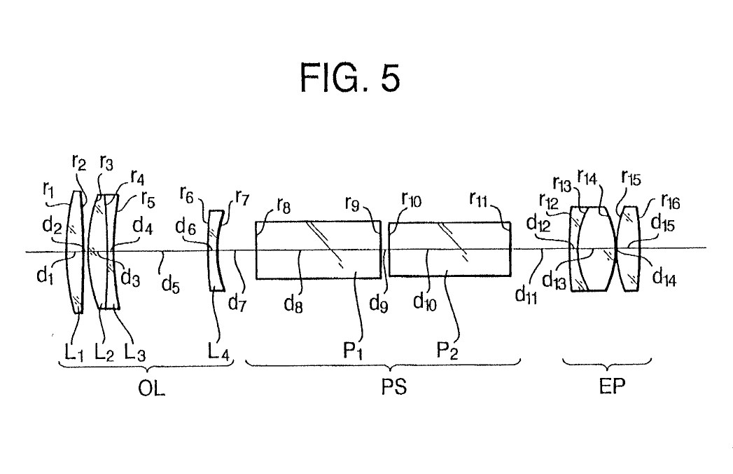

Hereafter, numerical embodiments of the telescopic optical systems will be described with reference to FIGS. 5 through 28

[First Embodiment]

FIG. 5 shows a telescopic optical system according to a first embodiment and the numerical construction thereof is described in TABLE 1. The objective optical system OL includes two lens groups having four lenses L1 through L4. The front lens group consists of the positive first lens L1, the positive second lens L2 and the negative third lens L3. The positive second lens L2 and the negative third lens L3 are cemented to each other. The rear lens group consists of the negative fourth lens L4. The rear lens group (L4) is a compensation lens group. The fourth lens L4 is a spherical lens, both surfaces of which are spherical. The prisms P1 and P2 of the erecting system PS are shown as plane parallel plates in FIG. 5.

In TABLE 1, r (mm) denotes a radius of curvature of a surface (the values at the vertex for aspherical surfaces), d (mm) denotes a distance between the surfaces along the optical axis, n denotes a refractive index at a wavelength of 588 nm and vd denotes an Abbe number.

TABLE 1

| Surface | | | | |
|---|---|---|---|---|
| Number | r | d | n | νd |
| #1 | 59.691 | 4.000 | 1.52249 | 59.8 |
| #2 | −218.165 | 1.500 | | |
| #3 | 36.085 | 5.000 | 1.51633 | 64.1 |
| #4 | −196.330 | 1.600 | 1.69895 | 30.1 |
| #5 | 75.486 | 24.258 | | |
| #6 | 119.106 | 2.000 | 1.51633 | 64.1 |
| #7 | 21.184 | 10.124 | | |
| #8 | INFINITY | 32.000 | 1.56883 | 56.3 |
| #9 | INFINITY | 2.000 | | |
| #10 | INFINITY | 32.000 | 1.56883 | 56.3 |
| #11 | INFINITY | 16.224 | | |
| #12 | −1121.162 | 1.500 | 1.80518 | 25.4 |
| #13 | 18.000 | 9.500 | 1.58913 | 61.2 |
| #14 | −19.364 | 0.500 | | |
| #15 | 21.849 | 5.500 | 1.69680 | 55.5 |
| #16 | −190.186 | | | |

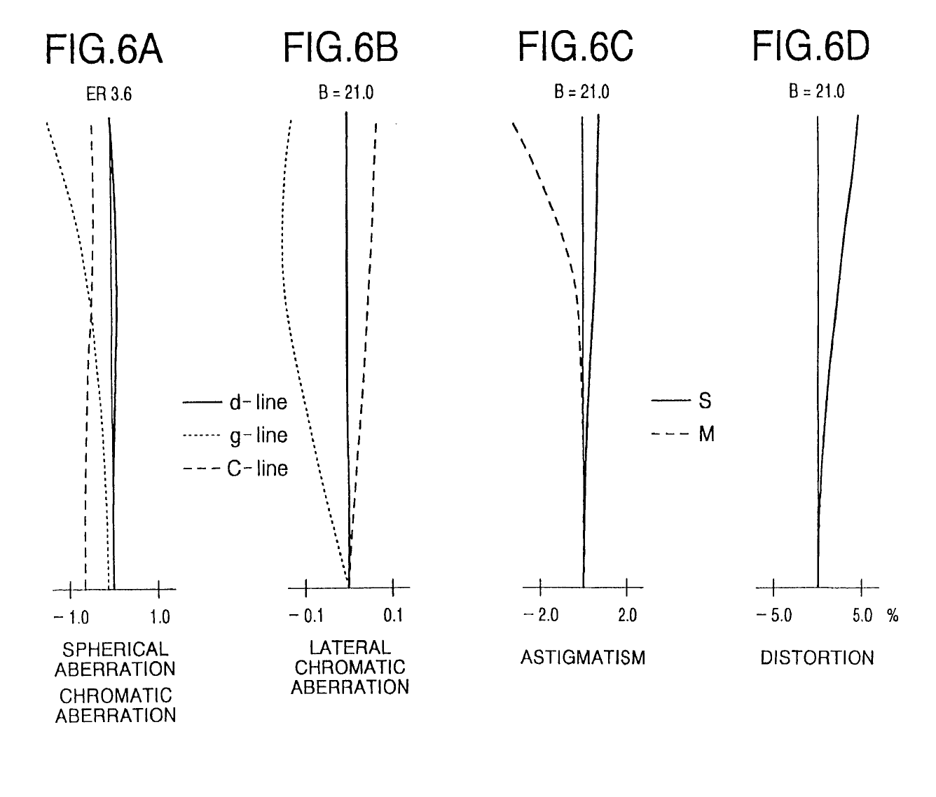

FIGS. 6A through 6D show third order aberrations of the telescopic optical system according to the first embodiment:

FIG. 6A shows spherical aberrations at d-line (588 nm), g-line (436 nm) and c-line (656 nm);

FIG. 6B shows a lateral chromatic aberration at the same wavelengths as in FIG. 6A;

FIG. 6C shows an astigmatism (S: Sagittal, M: Meridional); and

FIG. 6D shows distortion.

The vertical axis in FIG. 6A represents a diameter of an eye ring, and the vertical axes in FIGS. 6B through 6D respectively represent an angle B formed between the exit ray from the eyepiece and the optical axis Unit of the horizontal axis is “mm” in each of FIGS. 6A through 6C, and is “percent” in FIG. 6D.

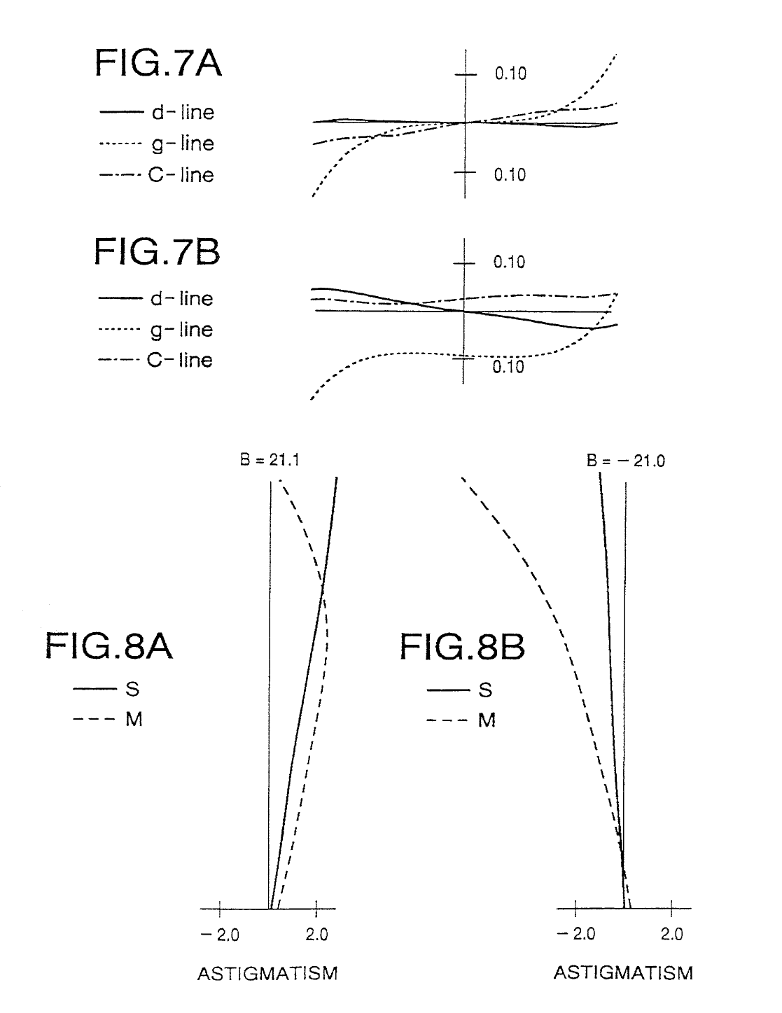

FIG. 7A is a graph showing transverse aberration of the telescopic optical system of the first embodiment when the rear lens group (L4) is not decentered, FIG. 7B is a graph showing the transverse aberration where the rear lens group (L4) is decentered to stabilize the image when the tilt angle due to the hand-held shaking is 1 degree.

FIGS. 8A and 8B show astigmatisms of the telescopic optical system of the first embodiment when the rear lens group (L4) is decentered to stabilize an image when a tilt angle is 1 degree.

[Second Embodiment]

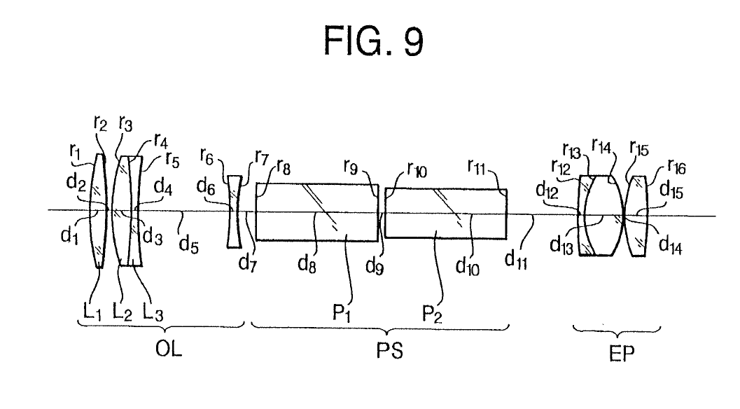

FIG. 9 shows an optical system according to a second embodiment. The numerical construction of the second embodiment is indicated in TABLE 2. The objective optical system OL includes two lens groups having four lenses L1 through L4. The front lens group consists of the positive first lens L1, the positive second lens L2 and the negative third lens L3, the rear lens group consists of the negative fourth lens L4 that is an aspherical lens. The positive second lens L2 and the negative third lens L3 are cemented to each other. The rear lens group (L4) is a compensation lens group.

TABLE 2

| Surface | | | | |
|---|---|---|---|---|
| Number | r | d | n | νd |
| #1 | 62.948 | 4.000 | 1.52249 | 59.8 |
| #2 | −106.302 | 1.500 | | |
| #3 | 38.414 | 5.000 | 1.51633 | 64.1 |
| #4 | −115.532 | 1.600 | 1.69895 | 30.1 |
| #5 | 73.293 | 24.059 | | |
| #6 | −62.769 | 2.000 | 1.49176 | 57.4 |
| #7 | 40.315 | 5.188 | | |
| #8 | INFINITY | 32.000 | 1.56883 | 56.3 |
| #9 | INFINITY | 2.000 | | |
| #10 | INFINITY | 32.000 | 1.56883 | 56.3 |
| #11 | INFINITY | 19.531 | | |
| #12 | 356.857 | 1.500 | 1.80518 | 25.4 |
| #13 | 17.000 | 10.000 | 1.58913 | 61.2 |
| #14 | −18.889 | 0.500 | | |
| #15 | 24.597 | 5.500 | 1.69680 | 55.5 |
| #16 | −110.236 | — | | |

The image side surface #7 of the fourth lens L4 is an aspherical surface. An aspherical surface is expressed by the following equation:

$$X ( h ) = \frac{{h}^{2} C}{1 + \sqrt{1 - ( 1 + K ) {h}^{2} {C}^{2}}} + {A}_{4} {h}^{4} + {A}_{6} {h}^{6} + {A}_{8} {h}^{8} + {A}_{10} {h}^{10}$$

where, X(h) is a SAG, that is, a distance of a curve from a tangential plane at a point on the surface where the height from the optical axis is h. C is a curvature (1/r) of the vertex of the surface, K is a conic constant, A₄, A₆, A₈ and A₁₀ are aspherical surface coefficients of fourth, sixth, eighth and tenth orders. The constant K and coefficient A₄ are indicated in TABLE 3. In the embodiments, coefficients A₆, A₈ and A₁₀ are equal to zero.

TABLE 3

| | | |
|---|---|---|
| 7th surface | K = 0.00000 | A₄ = −0.51726 × 10⁻⁵ |

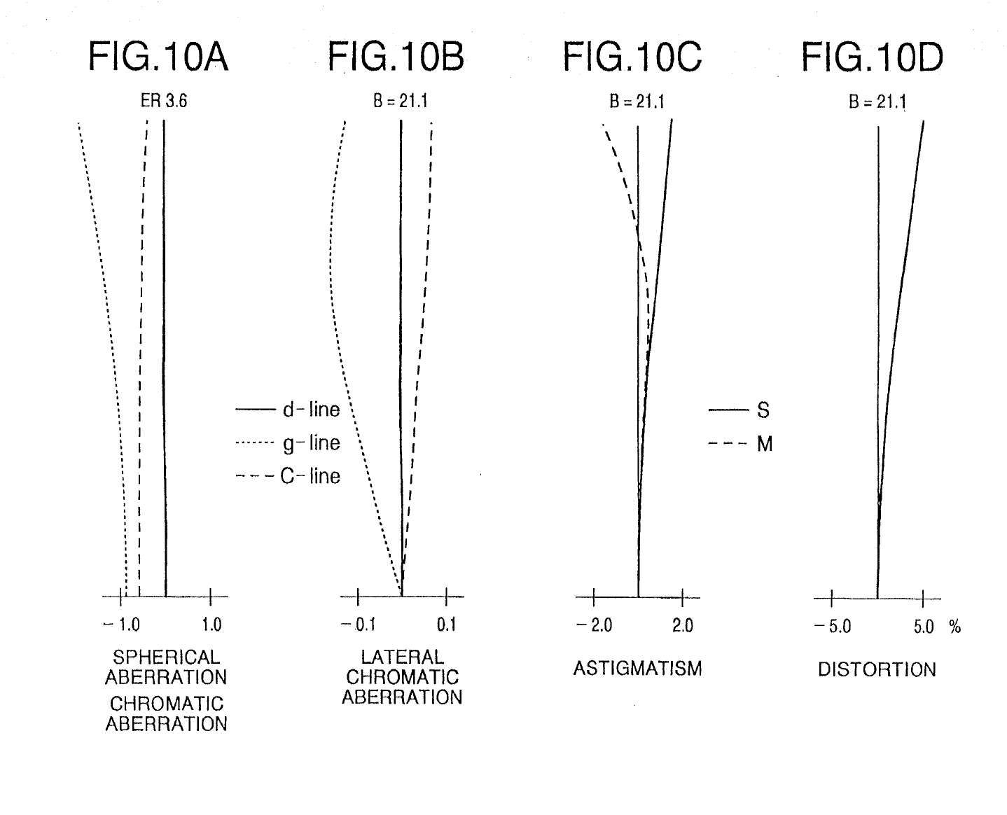

FIGS. 10A through 10D show third order aberrations of the telescopic optical system according to the second embodiment.

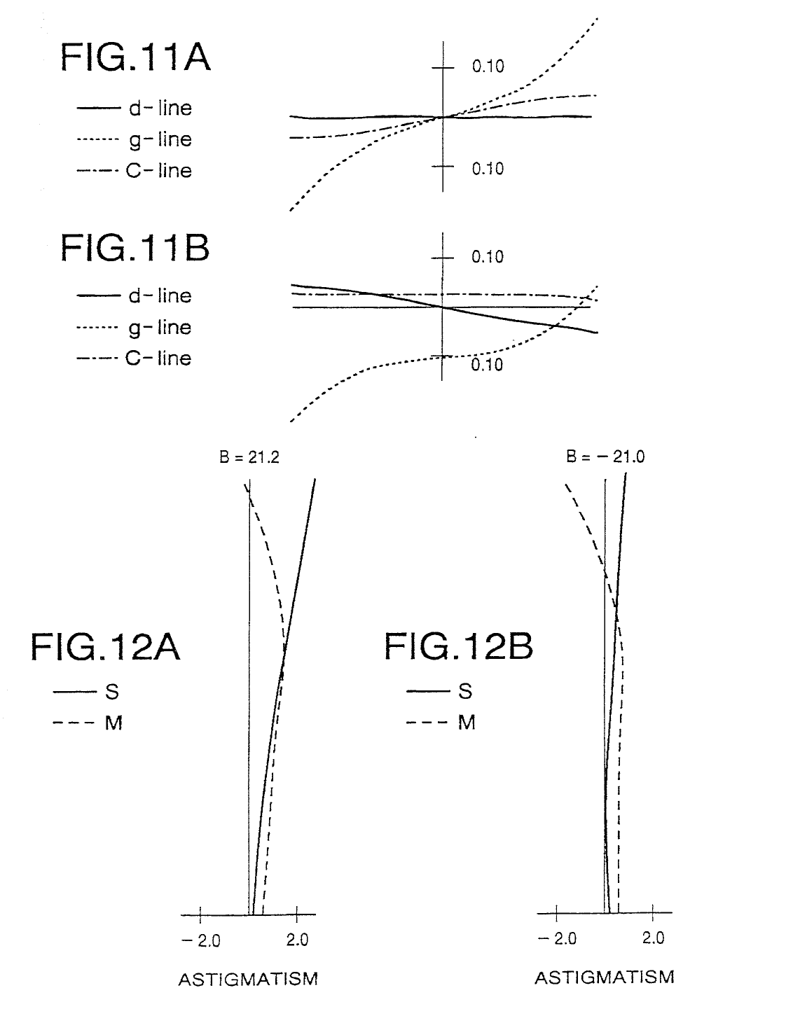

FIG. 11A is a graph showing the transverse aberration of the telescopic optical system of the second embodiment when the rear lens group (L4) is not decentered. FIG. 11B is a graph showing the transverse aberration when the rear lens group (L4) is decentered to stabilize the image when the tilt angle is 1 degree.

FIGS. 12A and 12B show astigmatisms of the telescopic optical system of the second embodiment when the rear lens group is decentered to stabilize an image when a tilt angle is 1 degree.

[Third Embodiment]

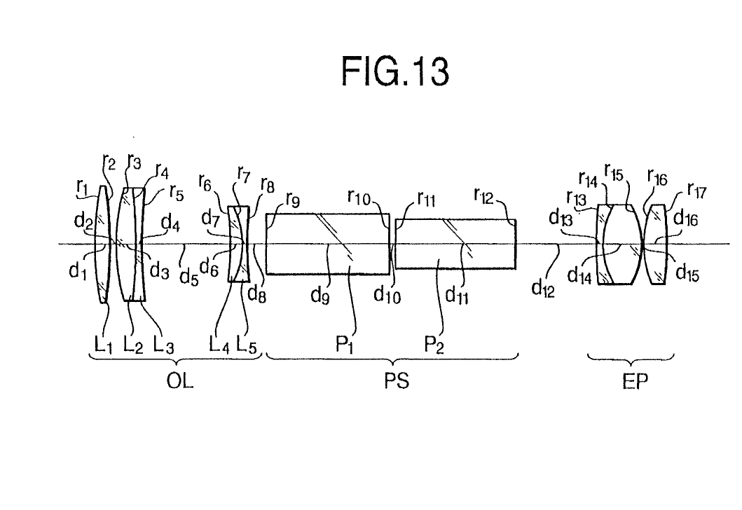

FIG. 13 shows an optical system according to a third embodiment, and the numerical construction thereof is indicated in TABLE 4. The objective optical system OL includes two lens groups having five lenses L1 through L5. The front lens group consists of the positive first lens L1, the positive second lens L2 and the negative third lens L3, the rear lens group consists of the positive fourth lens L4 and the negative fifth lens L5. The second lens and third lenses L2 and L3 are cemented to each other. The fourth and fifth lenses L4 and L5 are cemented to each other. The rear lens group (L4 and L5) is a compensation lens group.

TABLE 4

| Surface | | | | |
|---|---|---|---|---|
| Number | r | d | n | νd |
| #1 | 62.643 | 4.000 | 1.51633 | 64.1 |
| #2 | −108.110 | 1.500 | | |
| #3 | 39.873 | 5.000 | 1.51633 | 64.1 |
| #4 | −149.700 | 1.600 | 1.74077 | 27.8 |
| #5 | 79.045 | 23.236 | | |
| #6 | −48.022 | 3.000 | 1.62004 | 36.3 |
| #7 | −19.086 | 1.200 | 1.51633 | 64.1 |
| #8 | 42.514 | 5.000 | | |
| #9 | INFINITY | 32.000 | 1.56883 | 56.3 |
| #10 | INFINITY | 2.000 | | |
| #11 | INFINITY | 32.000 | 1.56883 | 56.3 |
| #12 | INFINITY | 20.974 | | |
| #13 | 356.857 | 1.500 | 1.80518 | 25.4 |
| #14 | 17.000 | 10.000 | 1.58913 | 61.2 |
| #15 | −18.889 | 0.500 | | |
| #16 | 24.597 | 5.500 | 1.69680 | 55.5 |
| #17 | −110.236 | | | |

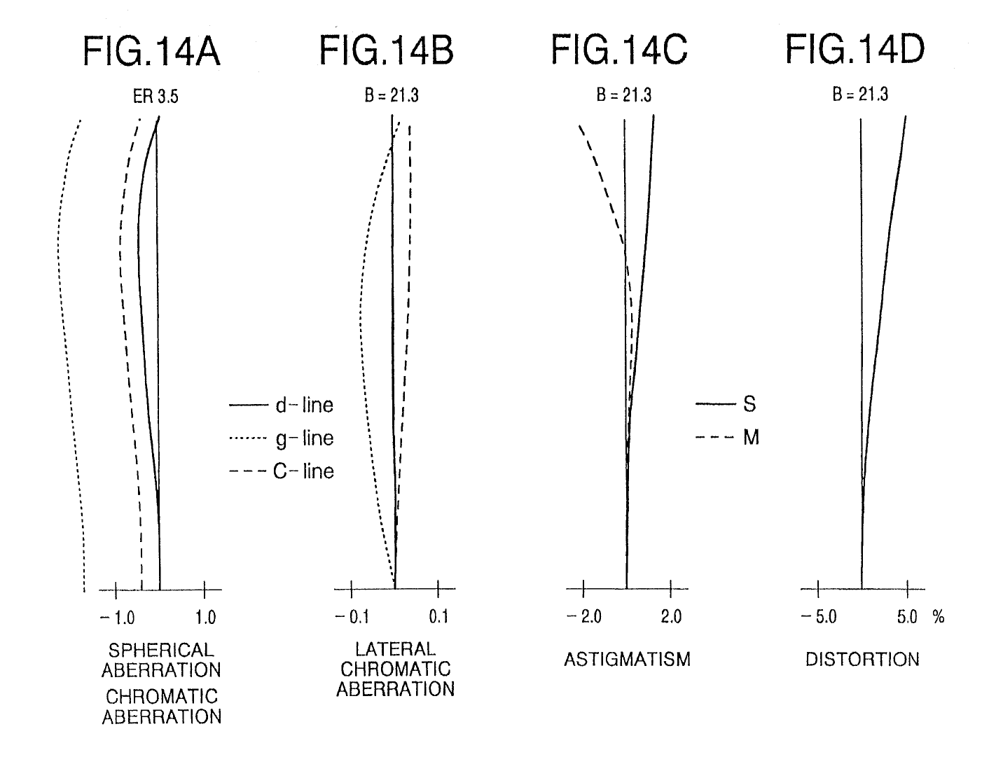

FIGS. 14A through 14D show third order aberrations of the telescopic optical system according to the third embodiment.

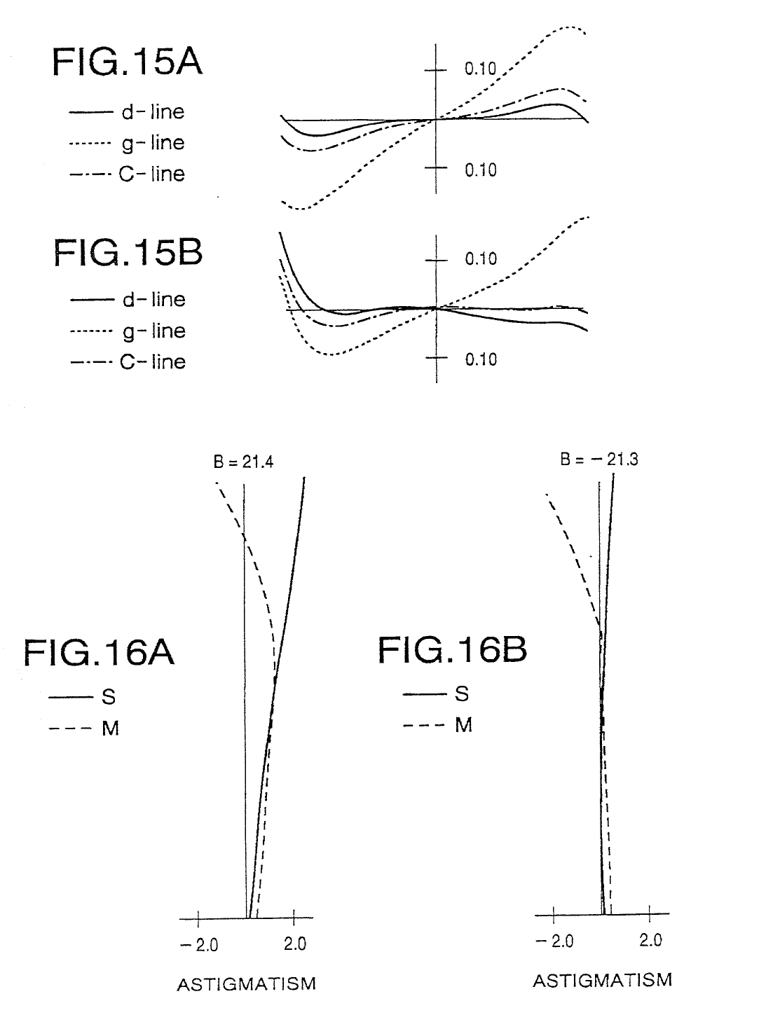

FIG. 15A is a graph showing the transverse aberration of the telescopic optical system of the third embodiment when the rear lens group (L4 and L5) is not decentered, and FIG. 15B is a graph showing the transverse aberration when the rear lens group (L4 and L5) is decentered to stabilize the image when the tilt angle is 1 degree.

FIGS. 16A and 16B show astigmatisms of the telescopic optical system of the third embodiment when the rear lens group is decentered to stabilize an image when a tilt angle is 1 degree.

[Fourth Embodiment]

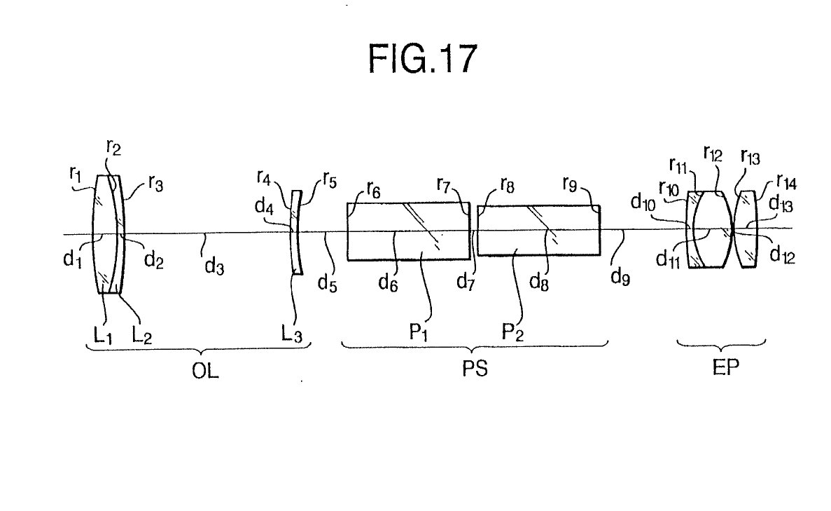

FIG. 17 shows an optical system according to a fourth embodiment. The numerical construction of the fourth embodiment is indicated in TABLE 5. The objective optical system OL includes two lens groups having three lenses L1 through L3. The front lens group consists of the positive first lens L1 and the negative second lens L2, the rear lens group consists of the negative third lens L4 that is a spherical lens. The positive first lens L1 and the negative second lens L2 are cemented to each other. The rear lens group (L3) is a compensation lens group.

TABLE 5

| Surface | | | | |
|---|---|---|---|---|
| Number | r | d | n | νd |
| #1 | 60.872 | 6.500 | 1.51454 | 54.7 |
| #2 | −44.193 | 1.600 | 1.69395 | 30.1 |
| #3 | −115.703 | 42.300 | | |
| #4 | 57.937 | 2.000 | 1.51633 | 54.1 |
| #5 | 38.053 | 12.578 | | |
| #6 | INFINITY | 32.000 | 1.56833 | 56.3 |
| #7 | INFINITY | 2.000 | | |
| #8 | INFINITY | 32.000 | 1.56883 | 56.3 |
| #9 | INFINITY | 22.796 | | |
| #10 | 958.820 | 1.500 | 1.80518 | 25.4 |
| #11 | 18.000 | 9.500 | 1.58913 | 61.2 |
| #12 | −20.252 | 0.500 | | |
| #13 | 21.041 | 5.500 | 1.69680 | 55.5 |
| #14 | −187.109 | | | |

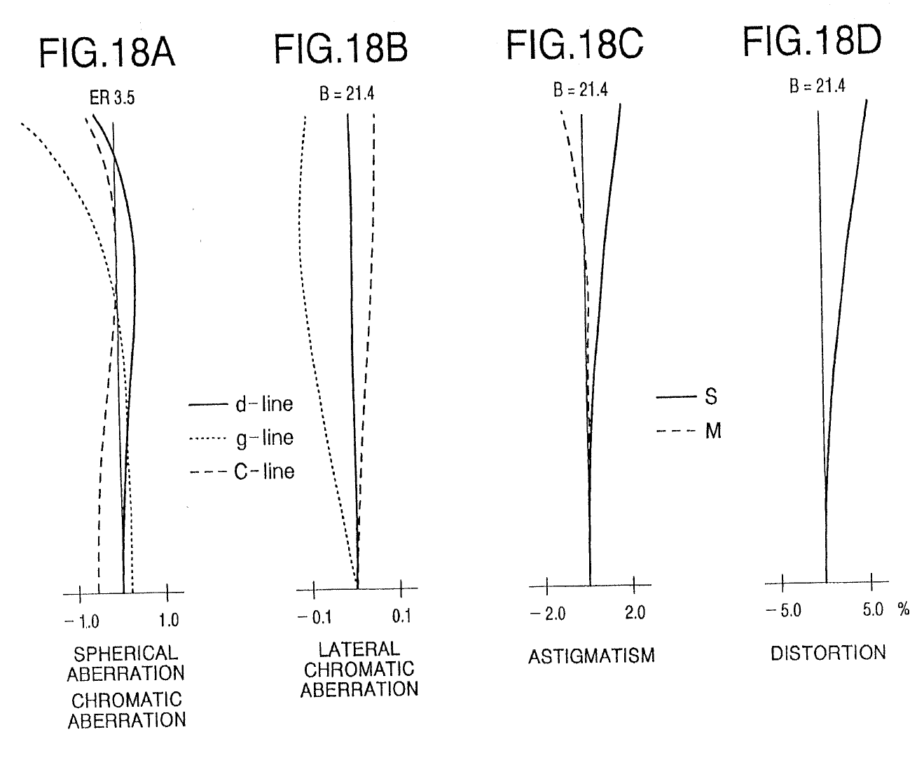

FIGS. 18A through 18D show third order aberrations Of the telescopic optical system according to the fourth embodiment.

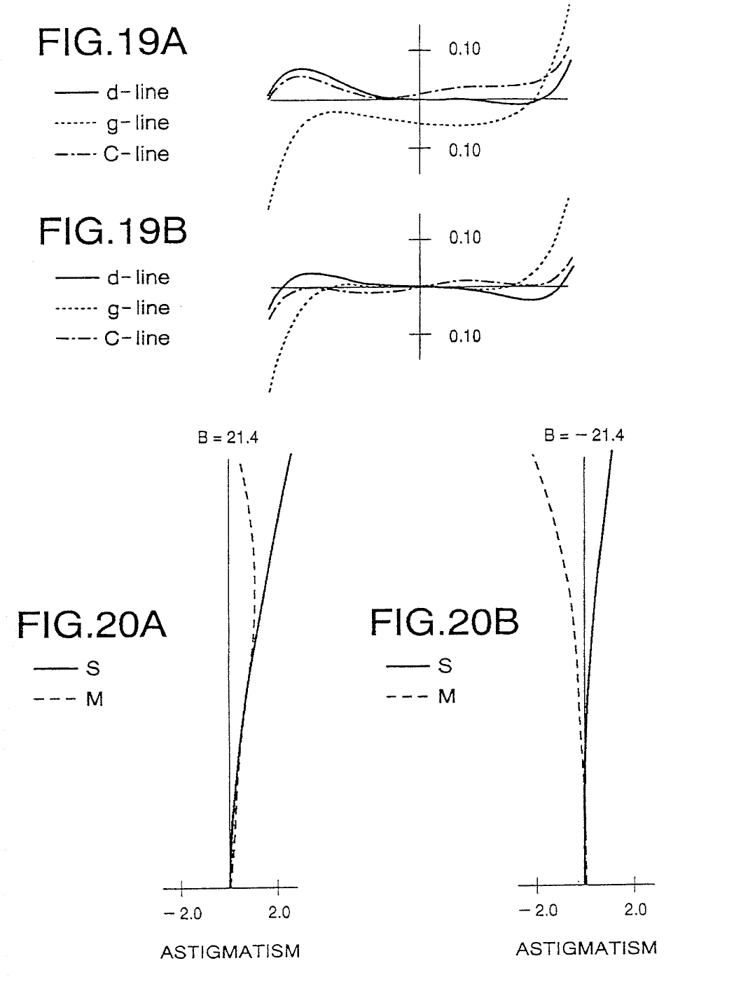

FIG. 19A is a graph showing the transverse aberration of the telescopic optical system of the fourth embodiment when the rear lens group (L3) is not decentered, and FIG. 19B is a graph showing the transverse aberration when the rear lens group (L3) is decentered to stabilize the image when the tilt angle is 1 degree.

FIGS. 20A and 20B show astigmatisms of the telescopic optical system of the fourth embodiment when the rear lens group is decentered to stabilize an image when a tilt angle is 1 degree.

[Fifth Embodiment]

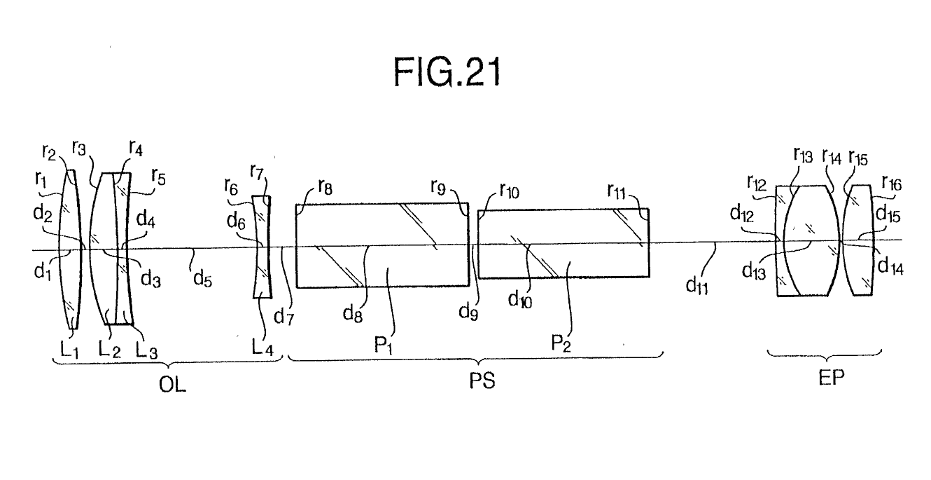

FIG. 21 shows an optical system according to a fifth embodiment. The numerical construction of the fifth embodiment is indicated in TABLE 6. The objective optical system OL includes two lens groups having four lenses L1 through L4. The front lens group consists of the positive first lens L1, the positive second lens L2 and the negative third lens L3, the rear lens group consists of the negative fourth lens L4 that is an aspherical lens. The positive second lens L2 and the negative third lens L3 are cemented to each other. The rear lens group (L4) is a compensation lens group.

TABLE 6

| Surface | | | | |
|---|---|---|---|---|
| Number | r | d | n | νd |
| #1 | 64.216 | 4.000 | 1.51633 | 64.1 |
| #2 | −92.954 | 1.500 | | |
| #3 | 40.523 | 5.000 | 1.51633 | 64.1 |
| #4 | −115.265 | 1.600 | 1.74950 | 35.3 |
| #5 | 81.358 | 23.540 | | |
| #6 | −37.965 | 2.000 | 1.49176 | 57.4 |
| #7 | 87.294 | 5.000 | | |
| #8 | INFINITY | 32.000 | 1.56883 | 56.3 |
| #9 | INFINITY | 2.000 | | |
| #10 | INFINITY | 32.000 | 1.56823 | 56.3 |
| #11 | INFINITY | 23.351 | | |
| #12 | 356.857 | 1.500 | 1.80518 | 25.4 |
| #13 | 17.000 | 10.000 | 1.58913 | 61.2 |
| #14 | −18.889 | 0.500 | | |
| #15 | 24.597 | 5.500 | 1.69680 | 55.5 |
| #16 | −110.236 | | | |

The object side surface #6 of the fourth lens L4 is an aspherical surface. The constant K and coefficient A₄ are indicated in TABLE 7. In the embodiments, coefficients A₆, A₈ and A₁₀ are equal to zero.

TABLE 7

| | | |
|---|---|---|
| 6th surface | K = 0.00000 | A₄ = 0.91565 × 10⁻⁵ |

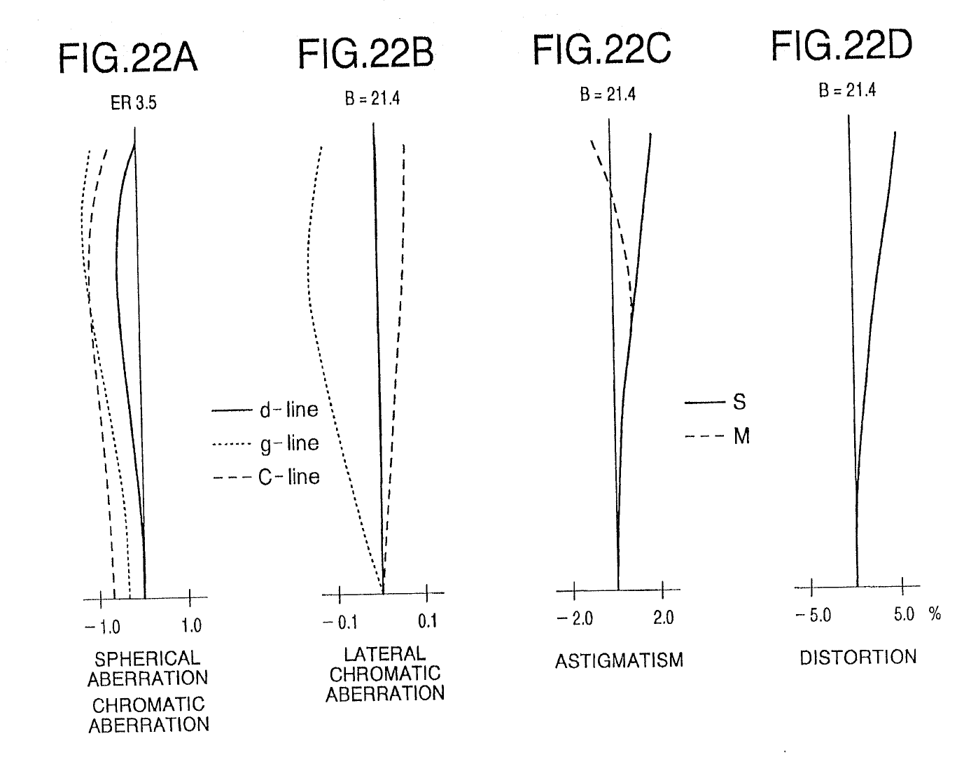

FIGS. 22A through 22D show third order aberrations of the telescopic optical system according to the fifth embodiment.

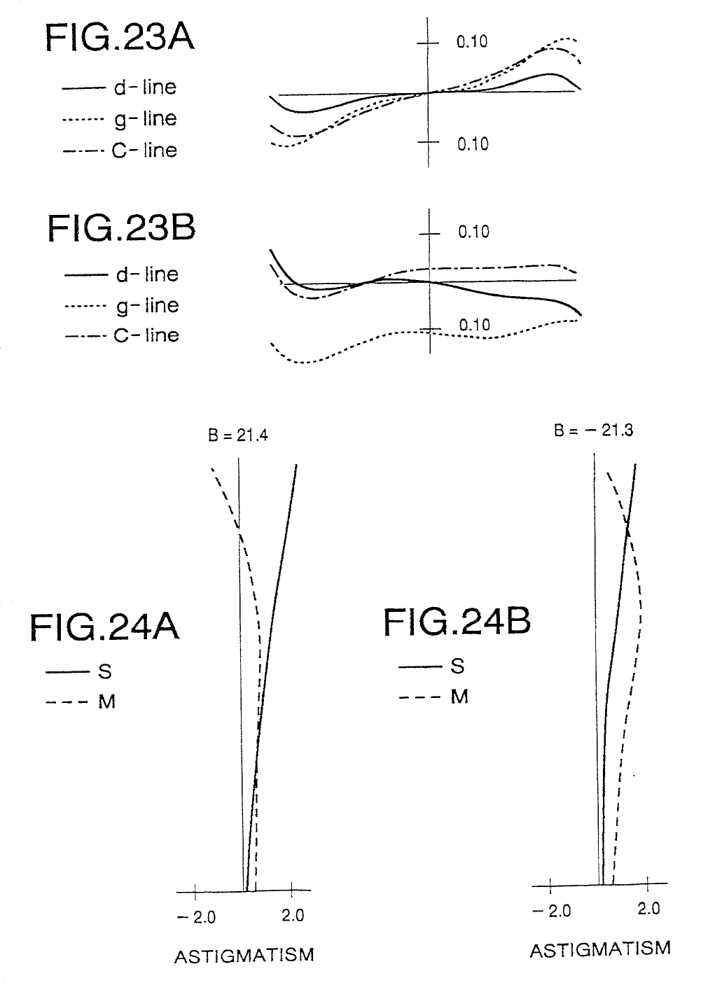

FIG. 23A is a graph showing the transverse aberration of the telescopic optical system of the fifth embodiment when the rear lens group (L4) is not decentered. FIG. 23B is a graph showing the transverse aberration when the rear lens group (L4) is decentered to stabilize the image when the tilt angle is 1 degree.

FIGS. 24A and 24B show astigmatisms of the telescopic optical system of the fifth embodiment when the rear lens group is decentered to stabilize an image when a tilt angle is 1 degree.

[Sixth Embodiment]

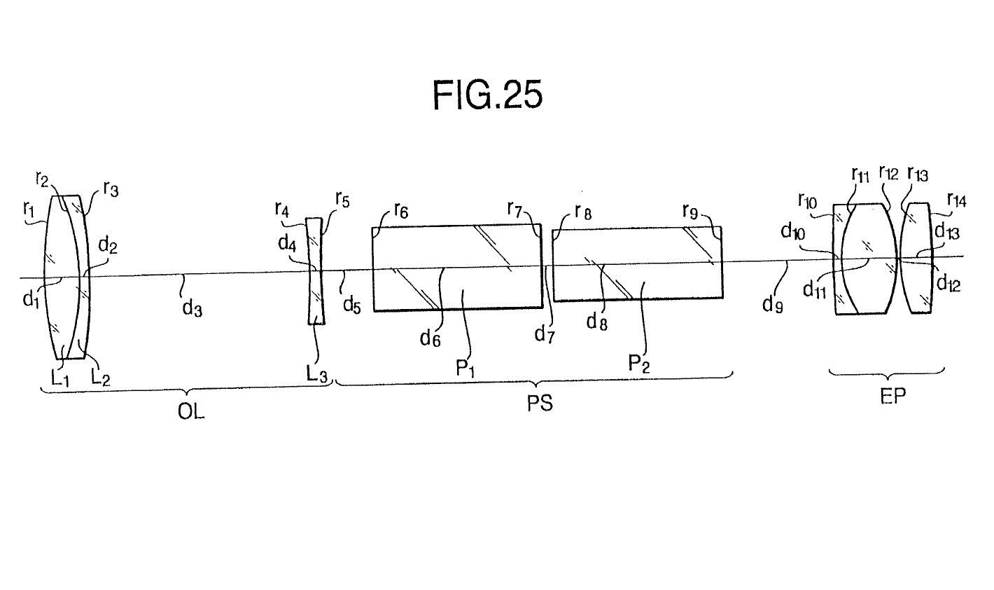

FIG. 25 shows an optical system according to a sixth embodiment. The numerical construction of the sixth embodiment is indicated in TABLE 8. The objective optical system OL includes two lens groups having three lenses L1 through L3. The front lens group consists of the positive first lens L1 and the negative second lens L2, the rear lens group consists of the negative third lens L3 that is an aspherical lens. The positive first lens L1 and the negative second lens L2 are cemented to each other. The rear lens group (L3) is a compensation lens group.

TABLE 8

| Surface | | | | |
|---|---|---|---|---|
| Number | r | d | n | νd |
| #1 | 65.268 | 6.500 | 1.51454 | 54.7 |
| #2 | −36.239 | 1.600 | 1.69895 | 30.1 |
| #3 | −77.074 | 40.397 | | |
| #4 | −106.242 | 2.000 | 1.52538 | 56.3 |
| #5 | 129.566 | 9.789 | | |
| #6 | INFINITY | 32.000 | 1.56883 | 56.3 |
| #7 | INFINITY | 2.000 | | |
| #8 | INFINITY | 32.000 | 1.56883 | 56.3 |
| #9 | INFINITY | 21.127 | | |
| #10 | 356.857 | 1.500 | 1.80518 | 25.4 |
| #11 | 17.000 | 10.000 | 1.58913 | 61.2 |
| #12 | −18.889 | 0.500 | | |
| #13 | 24.597 | 5.500 | 1.69680 | 55.5 |
| #14 | −110.236 | | | |

The object side surface #4 of the third lens L3 is an aspherical surface. The constant K and coefficient A₄ are indicated in TABLE 9. In the embodiments, coefficients A₆, A₈ and A₁₀ are equal to zero.

TABLE 9

| | | |
|---|---|---|
| 4th surface | K = 0.00000 | A₄ = 0.11112 × 10⁻⁵ |

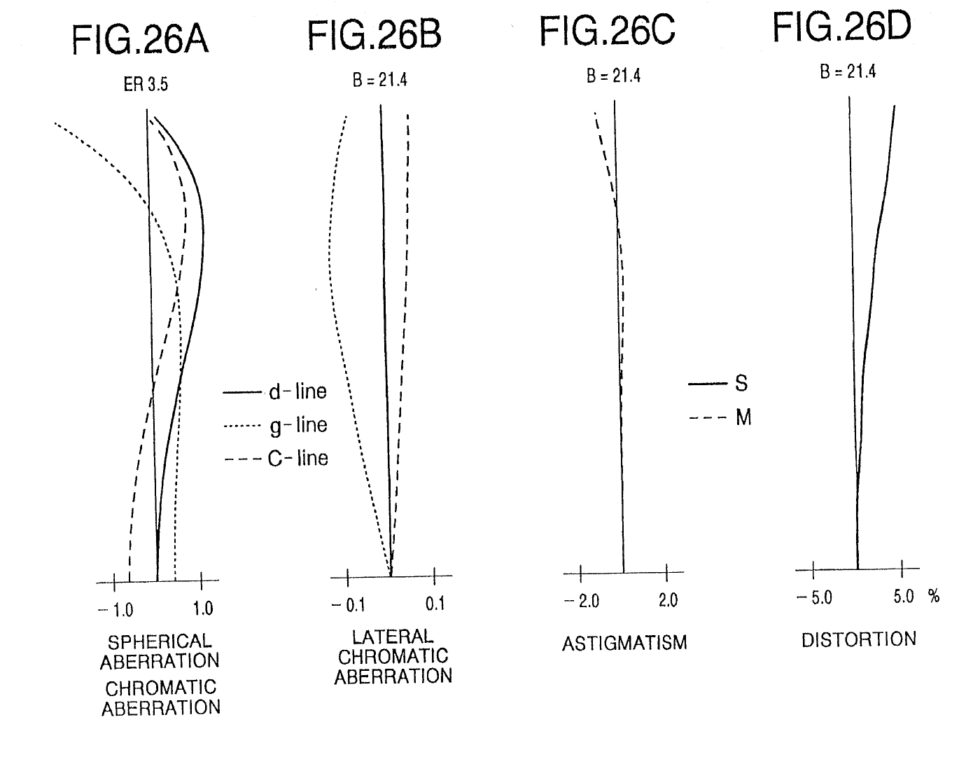

FIGS. 26A through 26D show third order aberrations of the telescopic optical system according to the sixth embodiment.

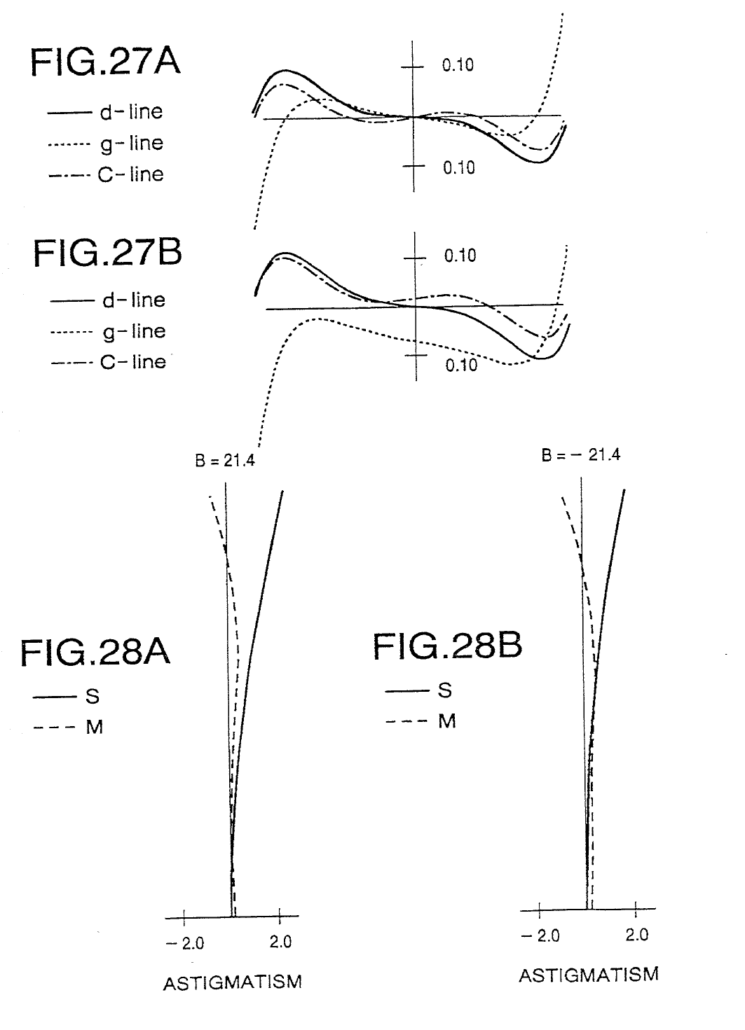

FIG. 27A is a graph showing the transverse aberration of the telescopic optical system of the sixth embodiment when the rear lens group (L3) is not decentered. FIG. 27B is a graph showing the transverse aberration when the rear lens group (L3) is decentered to stabilize the image when the tilt angle is 0.5 degrees.

FIGS. 28A and 28B show astigmatisms of the telescopic optical system of the sixth embodiment when the rear lens group is decentered to stabilize an image when a tilt angle is 0.5 degrees.

TABLE 10 shows the values of the first to third embodiments for conditions (1) to (5).

TABLE 10

| | Condition (1) | Condition 2 | Condition (3) |
|---|---|---|---|
| | m | (R₁+R₂)/(R₁−R₂) | (Ra₁+Ra₂)/(Ra₁−Ra₂) |
| 1st | 2.190 | 1.433 | — |
| Embodiment | | | |
| 2nd | 2.200 | — | 0.218 |
| Embodiment | | | |
| 3rd | 2.226 | — | — |
| Embodiment | | | |
| 4th | 1.394 | 3.543 | — |
| Embodiment | | | |
| 5th | 2.188 | — | −0.394 |
| Embodiment | | | |
| 6th | 1.595 | — | −0.099 |
| Embodiment | | | |

The condition (2) is directed to the embodiment where the rear lens group consists of a single spherical lens, no values are indicated for the second, third, fifth and sixth embodiments. The condition (3) is directed to the embodiment where the rear lens group consists of a single aspherical lens, no values are indicated for the first, third and fourth embodiments.

Each of the embodiments satisfies conditions directed thereof, and is suitable to the telescopic optical system of a binocular having an image-vibration compensation system.

It should be noted that, in the embodiments, the erected images are observed through the eyepiece EP. The invention is not limited to this particular structure, and is applicable to an observing equipment in which imaging devices (e.g., a CCD: a Charge Coupled Device) and an imaging lenses are used in place of, or in association with the eyepiece EP.

Further, in the above embodiments, the image-vibration compensation system is designed for compensating trembling of the image due to both the vertical and horizontal hand-held shakings. However, the system may be designed for compensating the hand-held shaking in one of these two directions according to uses.

The present invention is directed the optical system of an observing equipment that includes hand-held shaking sensors, sensors for detecting the position of the compensation lenses. However, the details of the hand-held shaking sensors and/or position detection sensors do not form part of the invention. These are provided to assist in understanding of the invention, and any types of suitable hand-held shaking sensors and/or position detecting sensors could be employed to control the driving mechanism for the compensation lenses.

The present disclosure relates to the subject matter contained in Japanese Patent Application No. HEI 10-1171, filed on Jan. 6, 1998, which is expressly incorporated herein by reference in its entirety.

What is claimed is:

1. An optical system for observing equipment having an image-vibration compensation system, said optical system including an objective optical system comprising:
a front lens group having positive refractive power; and
a rear lens group having negative refractive power, said lens groups being arranged in the order from an object side,
wherein:
said rear lens group is movable in a direction perpendicular to an optical axis of said objective optical system to compensate for a vibration of an image due to a hand-held shaking;
said rear lens group consists of a single negative aspherical lens of which thickness at its periphery is smaller than that of a spherical lens having the same paraxial radius of curvature; and
condition (1) is satisfied:
0.2<m<4.0 (1)
where m is a magnification of said rear lens group.

2. The optical system according to claim 1, wherein condition (2) is satisfied:
−5<(Ra₁+Ra₂)/(Ra₁−Ra₂)<1 (2)
where,
Ra₁ is a paraxial radius of curvature of the object side surface of said negative lens, and
Ra₂ is a paraxial radius of curvature of the image side surface of said negative lens.

3. An optical system for observing equipment having an image-vibration compensation system, said optical system including an objective optical system comprising:
a front lens group having positive refractive power; and
a rear lens group having negative refractive power, said lens groups being arranged in the order from an object side,
wherein:
said rear lens group is movable in a direction perpendicular to an optical axis of said objective optical system to compensate for a vibration of an image due to a hand-held shaking;
wherein said rear lens group comprises a positive lens and a negative lens so that chromatic aberration of said rear lens group is corrected; and
condition (1) is satisfied:
0.2<m<4.0 (1)
where m is a magnification of said rear lens group.
